(19) United States
(12) Patent Application Publication
(10) Pub. No.: US 2011/0267918 A1
(43) Pub. Date: Nov. 3, 2011

(54) STIR SYSTEM AND A METHOD FOR PROVIDING A CHEMICAL REACTION

(75) Inventors: Stephan Olivier van Banning, Ijmuiden (NL); Anita Coetzee, Delft (NL); Emilio René Bodenstaff, Delft (NL)

(73) Assignee: AVANTIUM HOLDING B.V., Amsterdam (NL)

(21) Appl. No.: 13/143,990

(22) PCT Filed: Jan. 15, 2010
(86) PCT No.: PCT/NL2010/000005

§ 371 Date: Jul. 11, 2011

(30) Foreign Application Priority Data
Jan. 15, 2009 (NL) 2002417

(51) Int. Cl. B01F 13/08; B01F 15/06; B01F 15/00; B01F 13/02

(52) U.S. Cl. 366/102; 366/144; 366/142; 366/204

(57) ABSTRACT

A stir system for stirring a liquid in a vial includes a top for at least partially closing the vial and a stirrer rotatable mounted in the top. The stirrer extends from the top into the vial and the stirrer is being connected with a magnet, which is rotatable during use by a rotating magnet field so as to rotate the stirrer in the vial. The system further includes a holder for holding the vial and a cover for covering the vial in the holder.

### CROSS-REFERENCE TO RELATED APPLICATIONS:

This application is the National Stage of International Application No. PCT/NL2010/000005, filed Jan. 15, 2010, which claims the benefit of Netherlands Application No. NL 2002417, filed Jan. 15, 2009, the contents of which is incorporated by reference herein.

### FIELD OF THE INVENTION

The invention relates to a stir system for stirring a liquid in a vial, the stir system comprising:
a top constructed for mounting on the vial; and,
a stirrer rotatable mounted in the top and during use extending from the top into the vial; the stirrer being connected with a stirrer magnet rotatable during use by a rotating magnet field so as to rotate the stirrer.

### BACKGROUND OF THE INVENTION

Stir systems may be used for stirring and mixing a liquid in a vial. U.S. Pat. No. 2,350,534 disclose a magnetic stirrer which will operate by magnetic action. A magnetic stirrer is put in the vial and by providing a rotating magnetic field the stirrer is rotated in the vial.

WO2008/112395 discloses a stirring apparatus which can be inserted in a liquid sample. The stirring apparatus is provided with a handle or grip portion.

US2003/0128626 discloses an apparatus for the addition of a compound or compound mixture to another including a primary and a secondary vessel. The secondary vessel is moveably mounted in the primary vessel for movement between a stored position and a mixing position.

U.S. Pat. No. 4,325,914 discloses a laboratory pressure vessel with a magnetic drive for mechanical stirring.

WO97/15366 discloses a distillation vessel with a combination stirrer. The actual paddle of the stirrer contains two magnets and is rotated outside the tube by the drive magnet.

### SUMMARY OF THE INVENTION

It is an object of the invention to provide an improvement or at least an alternative for the above mentioned stir system. According to an embodiment of the invention there is provided a stir system for stirring a liquid in a vial, the stir system comprising:
a top constructed for mounting on the vial; and,
a stirrer rotatable mounted in the top and during use extending from the top into the vial; the stirrer being connected with a stirrer magnet rotatable during use by a rotating magnet field so as to rotate the stirrer, wherein the system comprises:
a holder for holding the vial;
a cover for covering the vial and the top in the holder; and the holder or the cover is provided with driving magnets for providing a rotating magnet field for the stirrer magnet.

The top may be provided with an exit for providing a gas exit for gas from the vial. The exit may be connectable with a tube. The top may be provided with an entrance for providing a gas to the vial. The entrance may be connectable with a tube.

The top may be provided with a cooling element constructed and arranged for cooling a vapour above the liquid in the vial. This may be necessary for a reflux reaction in the vial.

The holder may be provided with a moveable magnet for providing the rotating magnet field. The rotating magnet field may be generated with an electro magnet. The holder may comprise a measurement device for measuring the rotational speed of the stirrer. The measurement device may be an optical sensor. The measurement device may be an induction measurement device for measuring the induction by the magnet. The stir system may comprise a control device constructed and arranged to adjust the speed of the rotating magnetic field if the measurement system measures a change in the rotational speed of the stirrer.

The cooling element is a metal element and the system is provided with a holder which has a cooling device in contact with the metal element so as to cool the metal element. The top is partially closing the vial.

According to an embodiment of the invention there is provided a method for providing a chemical reaction comprising:
providing a liquid in a vial;
providing a stirrer connected to a stirrer magnet rotatable in a top;
providing the top on the vial;
providing the vial in a holder
closing a cover over the holder; and,
providing a rotating magnet field to the stirrer magnet of the stirrer so as to rotate the stirrer in the liquid.

The method is advantageous for growing crystals in the vial.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a schematic cross-sectional view on a stir system according to the invention;

FIG. 2 depicts a view on the stir system of FIG. 1;

FIG. 3 depicts a view on the stir system of FIG. 1 provided with a holder for holding the vial;

FIG. 4 discloses a perspective side/bottom view on a stir system comprising two vials;

FIG. 5 discloses a side view on the stir system of FIG. 4; and,

FIG. 6 discloses a top view on the stir system of FIG. 4.

### DETAILED DESCRIPTION OF THE INVENTION

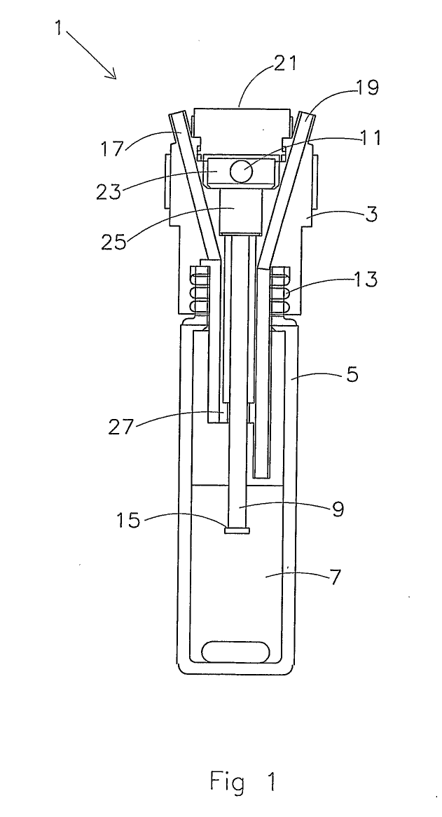

FIG. 1 schematically depicts a cross-sectional view on a stir system 1 according to the invention. The stir system may be provided with a top 3, which closes a vial 5 with a liquid 7. The stir system may be provided with a stirrer 9 rotatable mounted in the top 3 and provided with a stirrer magnet 11. By providing a rotating magnet field to the stirrer magnet 11 the stirrer 9 may be rotated so as to stir the liquid 7. The top 3 and the vial 5 may be provided with a screw thread 13 for screwing the top 3 on the vial 5. The stirrer 9 may be provided with a blade 15 for stirring the liquid 7.

The top 3 may be provided with an exit 17 for providing a gas exit for gas from the interior of the vial 5. The exit 17 may be connected with a tube to a vacuum pump (not shown) or may be closed off. The exit 17 may also be used for sampling of the liquid 7, for example by putting a needle of a syringe through the exit 17 into the liquid 7 to take a sample. The top may be provided with an entrance 19 for providing a gas to the vial 5 just above the level where the liquid 7 is. The entrance 19 may be connected with a tube for providing the gas to the interior of the vial 5.

For ease of use the top may be provided with a lid 21 which may be used to open the top 3. The stirrer 9 may be moved a little up relative to the liquid 7 so as to remove the stirrer magnet 11 from the circular member 23. The circular member may be provided with a lower part 25, which functions as a bearing for the stirrer 9. The circular member 23 may be provided with a screw thread for removably connecting to the rest of the stirrer 9. Preferably the circular member 23 and the lower part 25 may be made of a plastic, for example Teflon™ so as to provide low friction rotation of the stirrer 9 in the top 3. A lower bearing 27 may be used to provide for bearing of the stirrer 9 at the lower end of the top 3.

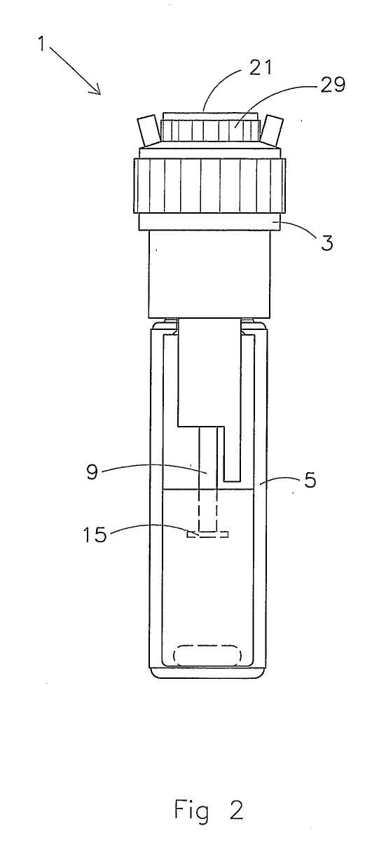

FIG. 2 depicts a view on the stir system 1 of FIG. 1. The top 3 may be provided with a top grip to provide for grip if the user releases the top 3 from the vial 5. The lid 21 may be provided with lid grip 29 to provide for grip if the lid 21 is released from the top 3. The blade 15 of the stirrer 9 is shown in a slightly rotated position with respect to the stir system of FIG. 1.

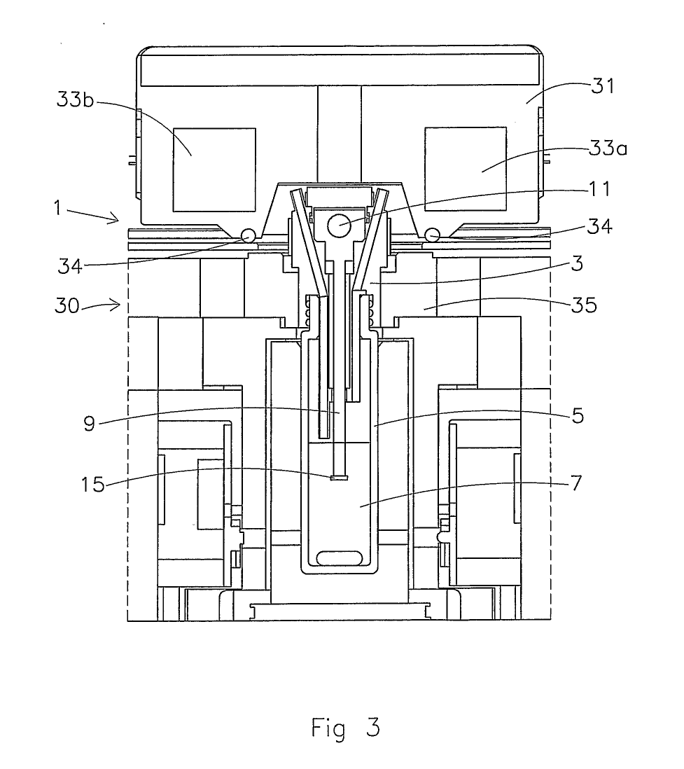

FIG. 3 depicts a view on the stir system 1 of FIG. 1 provided with a holder 30 for holding the vial 5. The holder 30 may be provided with a cover 31 provided with two driving magnets 33a and 33b, for example coils for providing a rotating magnet field so as to drive the stirrer magnet 11 in a rotational direction. The rotating stirrer magnet 11 will be driving the stirrer 9 so as to rotate the blade 15 which stirs the liquid 7. The cover 31 may be connected with a hinge to the rest of the holder for opening the cover 31 from the holder 30. The vial 5 and the top 3 with the stirrer 9 is kept relatively simple and light weight in this way while the heavy driving electromagnets 33 with their electric connections may be provided to the cover 31. The vial 5 and the top 3 may be kept easily moveable for a user in this way. To close the space between the cover 31 and the rest of the holder 30, a rubber 34 (e.g. an O-ring) may be provided between the cover 31 and the rest of the holder 30. This may assure that no liquid may escape from the stir system.

The holder 30 may be provided with a heater for heating the vial 5. The top 3 may be provided with a cooling element which may cool a vapour above the liquid so that the vapour condenses and will drop back into the liquid for reflux. The cooling element may be a metal cooled with a cooling device 35 (e.g. a piezo element or a chiller) surrounding the top 3.

The holder 30 may be provided with a measurement device, for example an optical measurement device or a coil induction measurement device for measuring the rotational speed of the stirrer 9. The coil induction measurement device may measure the induction in a coil caused by the rotating magnet 11. The coil for measuring the induction may be part of the driving magnets 33a or 33b or may be a separate coil. A controller for controlling the rotational speed of the stirrer may be connected with the measurement device and with the driving magnets 33a and 33b. The controller may adjust the rotational speed of the stirrer 9 if the viscosity of the liquid 7 changes. This may be advantageous for example if the reaction starts with a liquid 7 with a very high viscosity and stirring is started with a very low speed. The stirring speed may be increased if the viscosity decreases by a pre-programmed program or the measurement device for measuring the rotational speed of the stirrer may provide feedback that the viscosity decreases. The control system may than increase the rotational speed of the stirrer. The control system takes care that the rotating magnetic field is commutated with the stirrer magnet 11 and the speed of the rotating magnetic field may be decreased if the rotational speed of the stirrer decreases by increasing viscosity. This may circumvent grinding of any crystals that may grow in the liquid 7. The driving magnets 33a and 33b may be rotated with an electromotor so as to provide the rotating magnetic field or the driving magnets 33a and 33b may be stationary electro magnets which magnetic field may be adjusted to create a rotating magnet field.

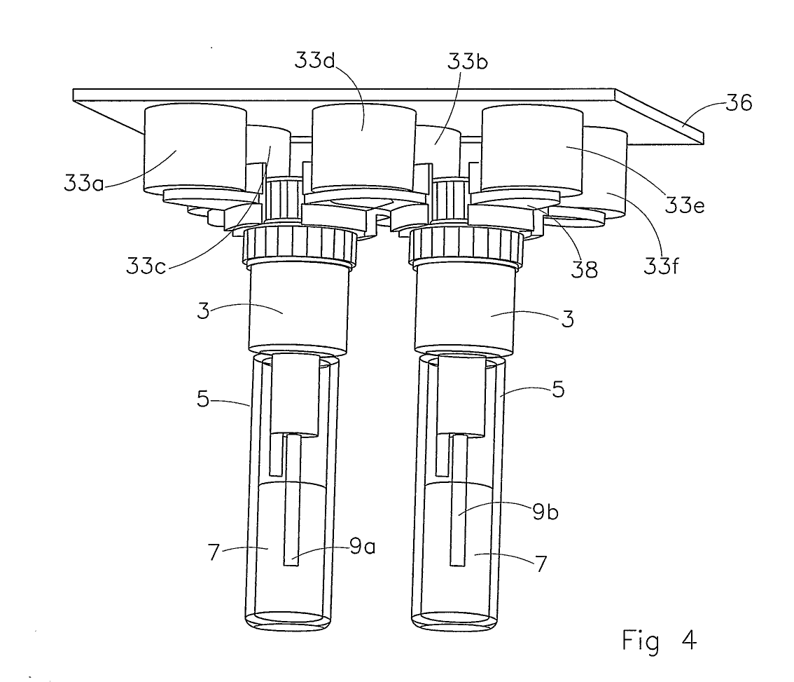

FIG. 4 discloses a perspective side/bottom view on a stir system for parallel processing of two vials 5 in which a portion of the holder is left away to show the details of the driving magnets 33a to 33f. The driving magnets 33a to 33f may be electromagnets. The driving magnets may be provided to a cover 31 from which a plate 36 is shown. It may be possible to open the cover 31 so as to position the vials 5 in the holder 30 when the cover and the magnets are moved away from the holder 30. This assures easy assess to the vials and easy mobility of the vials 5. The plate 36 may be made from metal preferably magnetic metal such as iron, nickel or cobalt so as to increase the strength of the magnet field produced. In an alternative embodiment the cover may be provided with holes so as to position the vials 5 through holes in the plate 36. The driving magnets 33a to 33f are provided with pole shoes 38 so as to increase the magnetic field of the driving magnet. The pole shoes may be made from a magnetic metal such as iron, nickel or cobalt so as to increase the strength of the magnet field produced. Four driving magnets for example 33a to 33d may be used to rotate the stirrer 9a in a first vial 5 and four driving magnets 33b 33d, 33e and 33f may be used to rotate the stirrer 9b in the second vial 5. The driving magnets 33b and 33d function for both vials 5. The stirrer may therefore be rotating in opposite directions or the driving magnets 33b and 33d may be adapted so as to control the direction of both stirrers 9. The vials 5 are provided with a top 3 enclosing the liquid 7 in the vials 5.

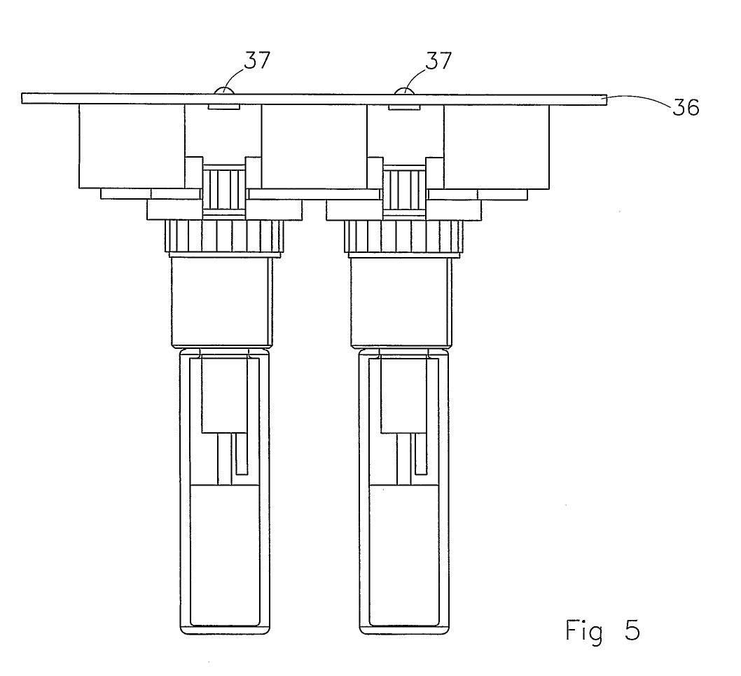

FIG. 5 discloses a side view on the stir system of FIG. 4. In the plate 33 signalling lights 35, for example a light emitting diode may be present for indicating that the stirrer is functioning. This may help to prevent a situation that a user opens the cover 31 while the stirrer is rotating.

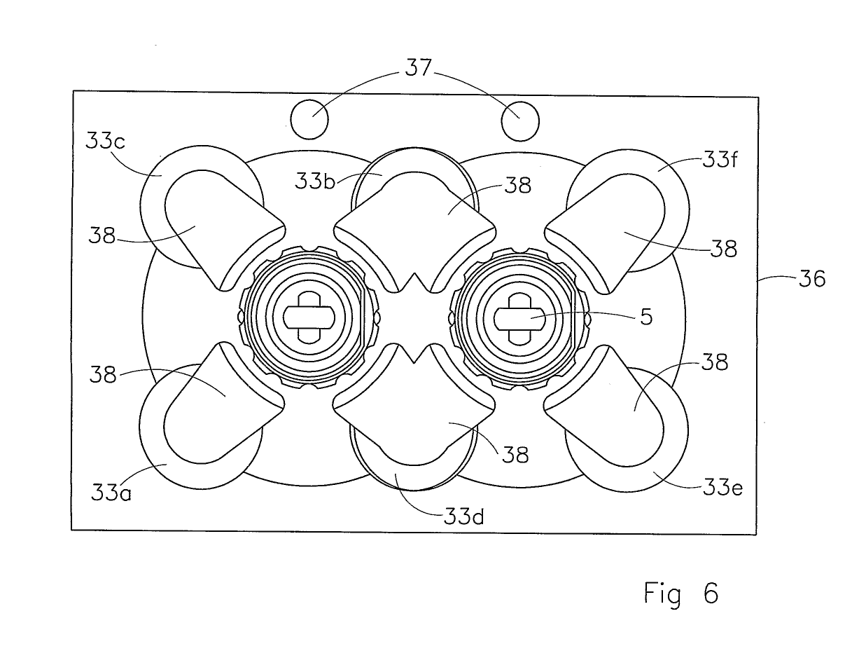

FIG. 6 discloses a bottom view on the stir system. The plate 36 is shown comprising the signalling lights 35. The vials 5 are surrounded by the driving magnets 33a to 33f with their respective pole shoes 38.

While specific embodiments of the invention have been described above, it will be appreciated that the invention may be practised otherwise than as described. For example, the electromagnets may be replaced by rotating permanent magnets or the magnets may be removed from the cover 31 to the lower part of the holder. For example, the invention may take the form of a computer program containing one or more sequences of machine-readable instructions describing a method as disclosed above, or a data storage medium (e.g. semiconductor memory, magnetical or optical disk) having such a computer program stored therein.

The descriptions above are intended to be illustrative, not limiting. Thus it will be apparent to one skilled in the art that modifications may be made to the invention as described without departing from the scope of clauses set out below.

1. A stir system for stirring a liquid in a vial, the stir system comprising:
a top constructed for direct mounting on the vial; and
a stirrer rotatable mounted in the top and during use extending from the top into the vial; the stirrer being connected with a stirrer magnet rotatable during use by a rotating magnet field so as to rotate the stirrer, wherein the system comprises:
a holder for holding the vial; and
a cover for covering the vial and the top in the holder; and the holder or the cover is provided with driving magnets for providing a rotating magnet field for the stirrer magnet.

2. The Stir system according to claim 1, wherein the top is provided with an exit for
providing a gas exit for gas from the vial.

3. The Stir system according to claim 2, wherein the exit is constructed and arranged to
be connectable with a tube.

4. The Stir system according to claim 1, wherein the top is provided with an entrance for providing a gas to the vial.

5. The Stir system according to claim 4, wherein the entrance is constructed and arranged to be connectable with a tube.

6. The Stir system according to claim 1, wherein the top is provided with a cooling element constructed and arranged for cooling a vapour above the liquid in the vial.

7. The Stir system according to claim 1, wherein the cover or the holder is provided with a moveable driving magnet for providing the rotating magnet field.

8. The Stir system according to claim 1, wherein the cover or the holder is provided with driving electromagnets constructed and arranged to create the rotating magnet field.

9. The Stir system according to claim 1, wherein the holder comprises a measurement device for measuring the rotational speed of the stirrer.
The Stir system according to claim 9, wherein the measurement device is an optical sensor.

11. The Stir system according to claim 9, wherein the measurement device is an induction measurement device for measuring the induction by the driving magnet.

12. The Stir system according to claim 10, wherein the stir system comprises a control device constructed and arranged to adjust the speed of the rotating magnetic field if the measurement system measures a change in the rotational speed of the stirrer.

13. The Stir system according to claim 6, wherein the cooling element is a metal element and the system is provided with a cooling device in contact with the metal element so as to cool the metal element.

14. The Stir system according to claim 1, wherein the top is partially closing the vial.

15. A method for providing a chemical reaction comprising:
providing a liquid in a vial;
providing a stirrer connected to a stirrer magnet rotatable in a top;
providing the top directly on the vial;
providing the vial in a holder;
closing a cover over the holder; and
providing a rotating magnet field to the stirrer magnet of the stirrer so as to rotate the stirrer in the liquid.
